(19) United States
(12) Patent Application Publication
(10) Pub. No.: US 2011/0320114 A1
(43) Pub. Date: Dec. 29, 2011

(54) Map Annotation Messaging

(75) Inventors: William A.S. Buxton, Toronto (CA); Flora P. Goldthwaite, Seattle, WA (US)

(73) Assignee: Microsoft Corporation, Redmond, WA (US)

(21) Appl. No.: 12/825,233

(22) Filed: Jun. 28, 2010

(51) Int. Cl. G01C 21/00; G10L 15/00

(52) U.S. Cl. 701/200; 704/246; 704/E15.001

(57) ABSTRACT

A map annotation message including map annotation data that represents a route is received by a receiving device. The map annotation data is analyzed to determine a route represented by the map annotation message, and the determined route is presented by the receiving device.

### BACKGROUND

Map services (web-based or stand alone) provide users access to a wide range of geographic information and tools. For example, web-based map services enable users to enter a start location and a destination, resulting in a calculated route from the start location to the destination. Many such services allow a user to specify characteristics of a route (e.g., fastest travel time, shortest distance, etc.), or to modify a calculated route, adding for example, more scenic segments along the way. These services typically generate directions for navigating a calculated route that may, for example, be printed out and used as a reference while actually navigating a route.

In-car navigation systems, handheld global positioning system (GPS) devices, and GPS-enabled cell phones are a few examples of the many types of devices that are used by individuals for navigation assistance. For example, with an in-car navigation system, a user can enter a destination address. The navigation system calculates a route from the current location to the destination, and provides real-time directions for navigating the route as the user drives. Many navigation systems provide audio and visual cues for navigating a calculated route.

### SUMMARY

This document describes map annotation messaging. A map annotation message that includes any of a variety of data types is generated to represent a particular navigation route. The map annotation message is then transmitted to a receiving device. The map annotation message is analyzed to determine the navigation route represented by the message, and the receiving device presents the route, for example, to assist a user in navigating along the route from a start location to a destination.

A map annotation message may include any combination of data including, but not limited to, map data, audio data, image data, pointer data, ink data, and supplemental data. In an example implementation, temporal relationships between different data types included in the map annotation message are used to analyze the map annotation message to effectively determine the represented route. Optical character recognition (OCR) may be used to analyze map data presented as an image and voice recognition techniques may be used to analyze audio data (e.g., spoken directions for navigating a route).

When presenting a route represented by a map annotation message, the receiving device may present audio and/or visual cues generated by the receiving device based on the route. Alternatively, the receiving device may present audio and/or visual cues made up of data from the map annotation message. In another alternate implementation, while presenting the route represented by a map annotation message, the receiving device may augment data received in the message with audio and/or visual cues generated by the receiving device.

A receiving device may present a map annotation message differently at different times depending on a determined context. A context may be determined, for example, based on a prescribed function of the receiving device, the specific data types included in the map annotation message, or a perceived level of user activity

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an environment within which map annotation messaging may be implemented.

FIG. 2 is a block diagram that illustrates components of an example map annotation message.

FIG. 3 is a block diagram that illustrates receipt of a map annotation message by an in-car navigation system.

FIG. 4 is a pictorial diagram of an example presentation of a map annotation message by an in-car navigation system.

FIG. 5 is a block diagram that illustrates components of an example map annotation message.

FIG. 6 is a block diagram that illustrates receipt of a map annotation message by a hand-held global positioning system (GPS) device.

FIG. 7 is a block diagram that illustrates selected components of an example authoring device for generating map annotation messages.

FIG. 8 is a block diagram of select components of an example map annotation application.

FIG. 9 is a block diagram that illustrates selected components of a receiving device configured to present map annotation messages.

FIG. 10 is a block diagram of select components of an example geographic navigation application.

FIG. 11 is a flow diagram of an example process for generating and transmitting a map annotation message.

FIG. 12 is a flow diagram of an example process for receiving and analyzing a map annotation message.

FIG. 13 is a flow diagram of an example process for presenting a map annotation message.

FIG. 14 is a flow diagram of an example process for presenting a map annotation message based on a determined context.

FIG. 15 is a flow diagram of another example process for presenting a map annotation message based on a determined context.

### DETAILED DESCRIPTION

A map annotation message is generated by a user at an authoring device, and is transmitted to a receiving device. The receiving device presents the received map annotation message. In an example implementation, presentation of the map annotation message is based on a determined context. The context according to which the map annotation message is presented may be based on any number of factors, including, but not limited to, a prescribed function of the receiving device, the specific data types included in the map annotation message, and/or a perceived level of user activity. In other words, a single map annotation message may be presented differently by different receiving devices, or may be presented differently by the same receiving device depending on other factors, such as user activity.

The discussion begins with a section entitled “Example Environment,” which describes one non-limiting network environment in which map annotation messaging may be implemented. A section entitled “Example Map Annotation Messages” follows, and illustrates and describes structure and presentation of example map annotation messages. A third section, entitled “Example Authoring Device,” illustrates and describes an example device for generating a map annotation message. A fourth section, entitled “Example Receiving Device,” illustrates and describes an example device for receiving and presenting a map annotation message. A fifth section, entitled “Example Operation,” illustrates and describes example processes for generating, receiving, and presenting a map annotation message. Finally, the discussion ends with a brief conclusion.

This brief introduction, including section titles and corresponding summaries, is provided for the reader's convenience and is not intended to limit the scope of the claims, nor the proceeding sections.

### Example Environment

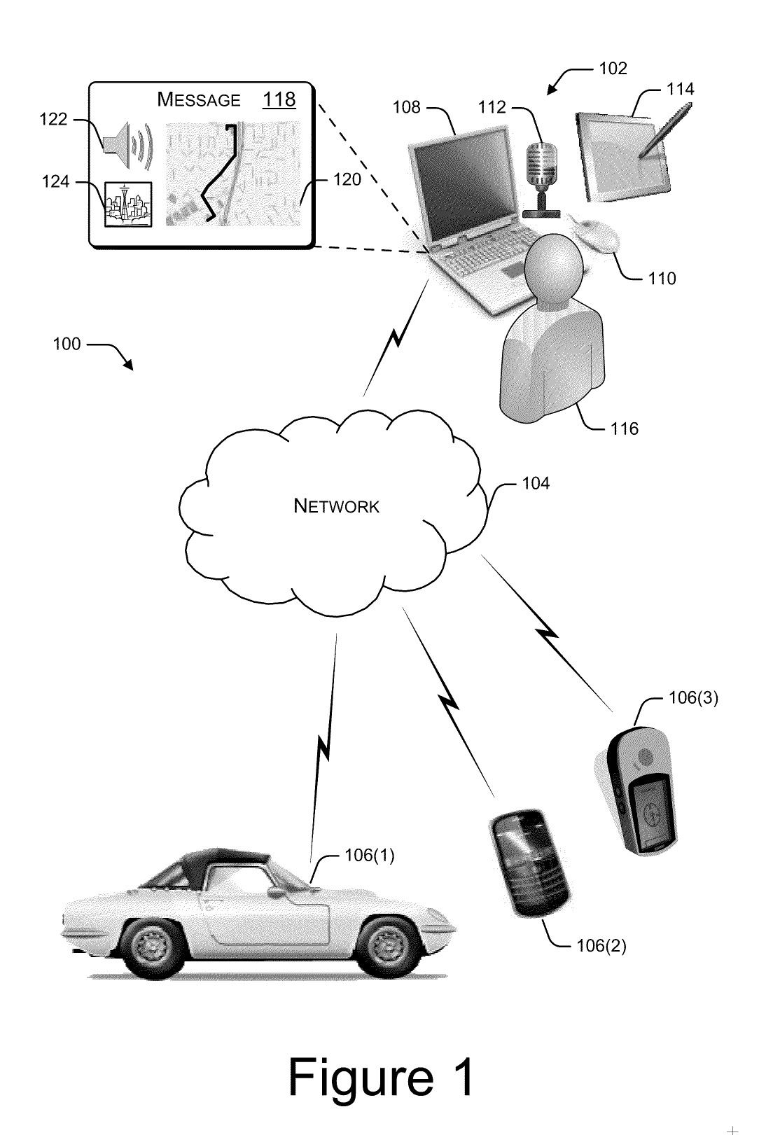

FIG. 1 illustrates an example environment 100 in which map annotation messaging may be implemented. Example environment 100 includes an authoring device 102, a network 104, and a receiving device 106. In FIG. 1, authoring device 102 is illustrated as a computer system that includes a laptop computer 108 with peripheral devices including a mouse 110, a microphone 112, and a pen tablet 114. An authoring device may be implemented in many forms, including, but not limited to, a personal computer, a mobile phone, or a mobile computing device. Authoring device 102 may be implemented as any device configurable to generate and transmit a map annotation message.

Using authoring device 102, a user 116 generates a map annotation message 118. Example map annotation message 118 is multi-dimensional, including map data 120, audio data 122, and image data 124. Map annotation message 118 is just one example of a map annotation message. Other examples of map annotation messages may include any combination of any number of data types. A map annotation message may be any electronic message that provides map annotation data, and that may be transmitted from an authoring device to a receiving device. A map annotation message may include a single type of data (e.g., audio data), or the map annotation message may be multi-dimensional, including multiple types of data (e.g., map data, ink data, and audio data).

Map annotation message 118 is transmitted over the network 104 to a receiving device 106. Network 104 may be any type of communication network, including, but not limited to, the Internet, a wide-area network, a local-area network, a satellite communication network, or a cellular telephone communications network.

FIG. 1 illustrates three specific examples of receiving devices, including an in-car navigation system 106(1), a mobile phone 106(2) and a mobile GPS device 106(3). The receiving devices 106 illustrated in FIG. 1 are merely three examples. In practice, a receiving device may be any device configurable to receive and present map annotation messages. Example receiving devices may include, but are not limited to, personal computers, in-car navigation systems, portable navigation systems, mobile phones, mobile computing devices, and mobile GPS devices.

### Example Map Annotation Messages

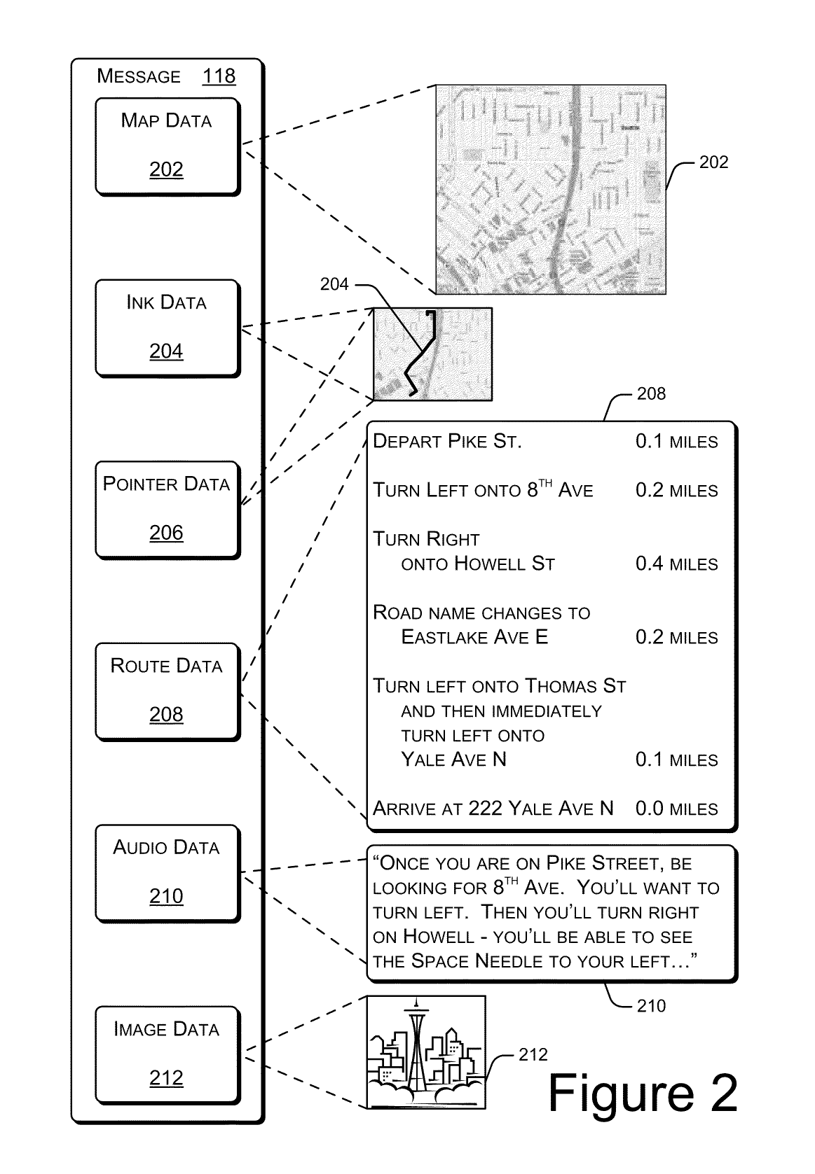

FIGS. 2-4 illustrate receipt and presentation of an example map annotation message through an in-car navigation system. FIG. 2 illustrates components of an example map annotation message 118. In the illustrated example, map annotation message 118 includes map data 202, ink data 204, pointer data 206, route data 208, audio data 210, and image data 212. Map data 202 may include, for example, a portion of a foundational map provided by a map service, such as Microsoft Corporation's Bing™ Maps.

Ink data 204 and pointer data 206 may include annotations over the map data. For example, ink data 204 may be generated when a user utilizes a pen tablet 114 to draw a route over the map data 202. Similarly, pointer data 206 may be generated when a user utilizes a mouse or other pointer device to identify points of interest related to the map data. For example, the user may point out various landmarks using a pointer device.

Route data 208 includes data that identifies a route that may be navigated. The route data may be generated, for example, by a map service, such as Microsoft Corporation's Bing™ Maps. Route data 208 typically includes a start location, a destination location, route segments between the start location and the destination location, and segment distances.

Audio data 210 may be generated by a user, for example using microphone 112. In the illustrated example, the audio data 210 includes user-generated audible directions for navigating the route.

In the illustrated example, map annotation message 118 also includes image data 212. In this example, image data 212 is a user-submitted photo of the Space Needle, which is referenced in the audio data as a landmark.

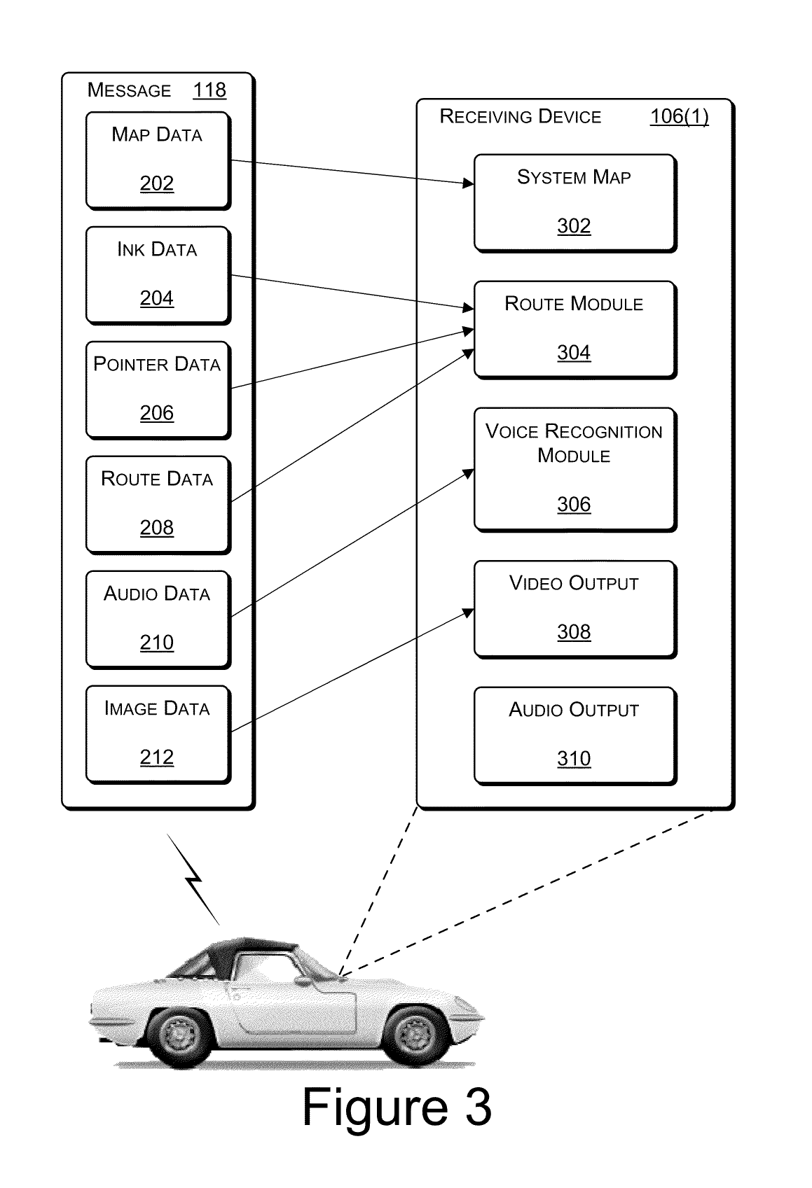

As discussed above with reference to FIG. 1, the generated map annotation message 118 is transmitted to a receiving device 106. FIG. 3 illustrates receipt of the map annotation message by receiving device 106(1), an in-car navigation system. FIG. 3 illustrates a correlation between select components of example receiving device 106(1) and components of the map annotation message 118.

Example receiving device 106(1) includes a system map 302, a route module 304, a voice recognition module 306, a video output 308, and an audio output 310. In the illustrated example, map data 202 from the map annotation message 118 is correlated with system map 302 of the receiving device 106(1). For example, map data 202 is analyzed to determine a geographic area represented by the map data 202. That same area is then identified in the system map 302.

Route data 208 is processed by route module 304 to determine a route that is formatted for use by the receiving device 106(1), and that correlates with the route data 208. The ink data 204 and pointer data 206 are also utilized by route module 304, for example, to further enhance the data associated with the determined route. For example, if the pointer data 206 identifies landmarks along the route, identification of those landmarks may be added to the device-formatted route data.

Audio data 210 is processed by voice recognition module 306, and segmented according to the route data 208. For example, the audio data 210 may be fairly short in duration (e.g., less than 2 minutes), while actually navigating the route may take at least several minutes. By segmenting the audio data according to the route, the receiving device 106(1) can present portions of the audio data at appropriate times during actual navigation of the route.

Image data 212 is output through the video output 308. In an example implementation, the image data is also correlated with the route data 208 and the audio data 210 so that the image data 212 is displayed at an appropriate time during actual navigation of the route.

In an example implementation, the various data components of the map annotation message 118 are processed in conjunction with one another to enable a contextual presentation of the message. For example, the ink and pointer data may temporally correspond to the audio data (e.g., the user who generated the message may have used a mouse or pen tablet to trace the route and point out landmarks, while simultaneously speaking the directions into a microphone). As such, words in the audio data 210, recognized by the voice recognition module 306, are correlated with road names in the route data 208 and with landmarks which may be represented in the image data 212. Furthermore, locations along the route may be determined, in part, based on recognition of words spoken in the audio data 210 at a time that corresponds to pointer data 206 that is at or near a particular location represented by the map data 202. By analyzing the various map annotation message components in correlation with one another, the audio and image data can then be presented at an appropriate time with relation to a route for which navigation directions are being presented.

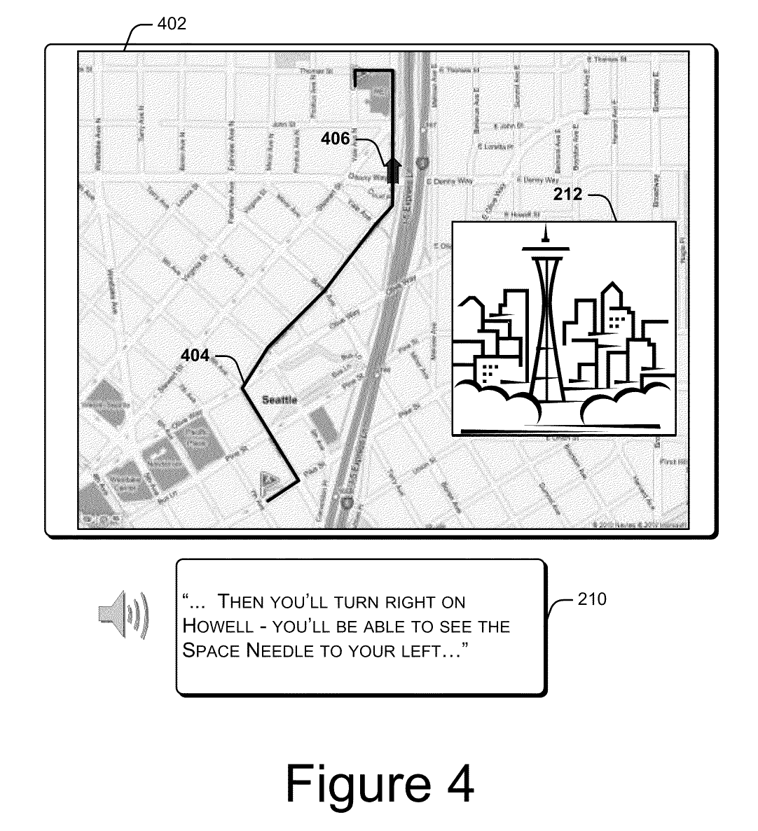

FIG. 4 illustrates an example display of in-car navigation system 106(1) as map annotation message 118 is presented. In-car navigation system 106(1) displays a map 402 with an indicated route 404. Arrow 406 indicates a current location. Simultaneously, and in the context of the current location, the audio data 210 from the map annotation message 118 is also presented, for example, through an audio output 310 associated with the in-car navigation system 106(1). As the audio referencing the Space Needle is played, the image of the Space Needle from image data 212 of the map annotation message 118 is also presented on the display device.

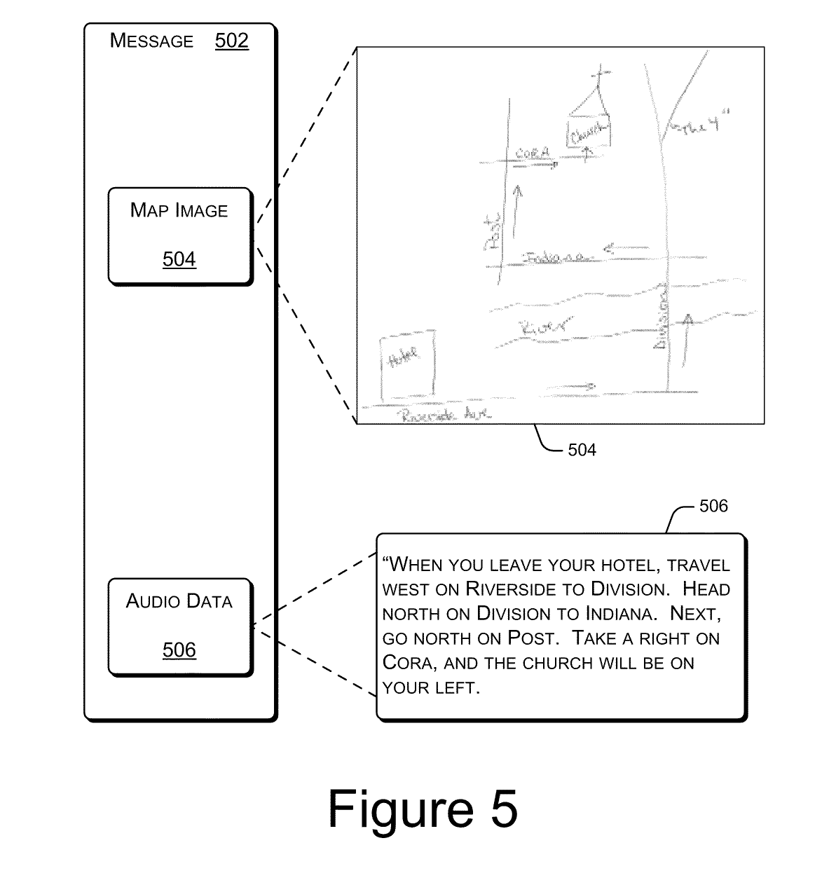

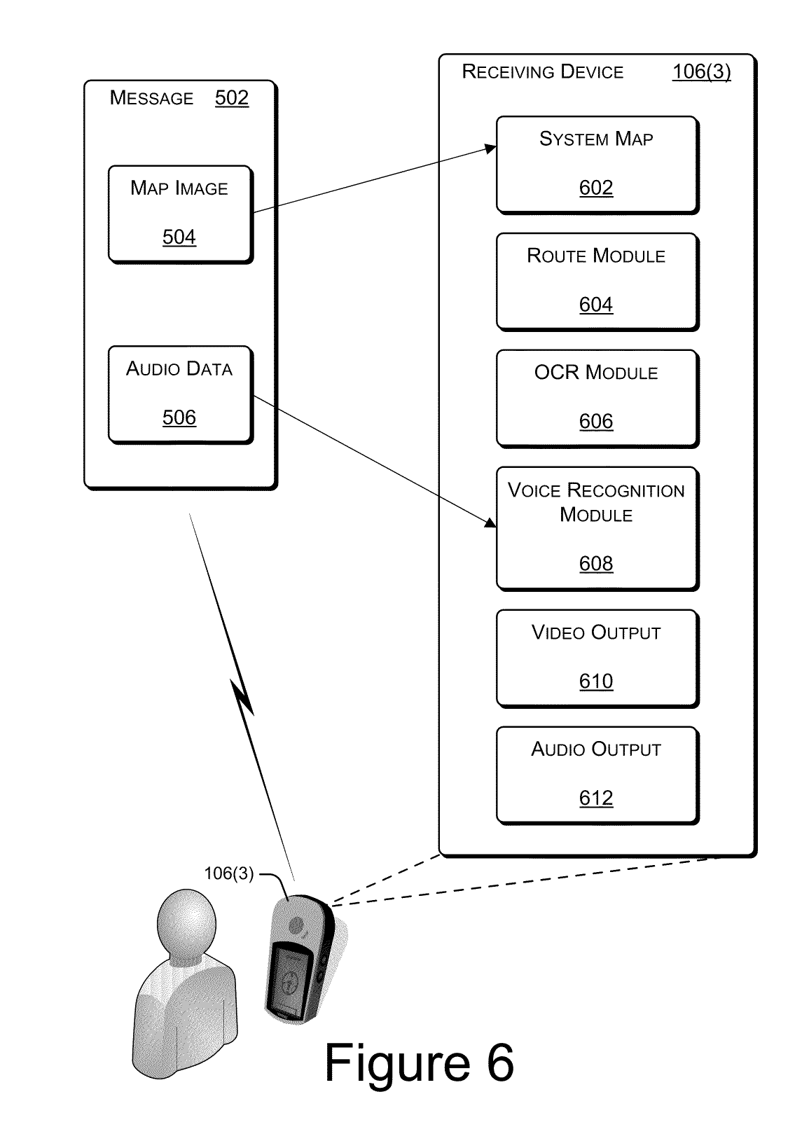

FIGS. 5 and 6 illustrate receipt of another example map annotation message by a mobile GPS device. FIG. 5 illustrates an example map annotation message 502 that includes only a map image 504 and audio data 506. As discussed above with reference to FIG. 2, a map annotation message may include a variety of types of data. In the example shown, rather than including pre-generated map data, the map annotation message 502 includes a scanned image of a hand-sketched map 504. Map annotation message 502 also includes audio data 506, which provides audible directions for navigating a route indicated on the hand-sketched map 504.

FIG. 6 illustrates receipt of map annotation message 502 by receiving device 106(3), a mobile GPS device. FIG. 6 illustrates a correlation between select components of example receiving device 106(3) and components of the map annotation message 502.

Example receiving device 106(3) includes a system map 602, a route module 604, an optical character recognition (OCR) module 606, a voice recognition module 608, a video output 610, and an audio output 612. In the illustrated example, the map image 504 from the map annotation message 502 is correlated with system map 602 of the receiving device 106(3). In an example implementation, OCR module 606 processes the map image 504 to identify keywords, such as road names, to identify a geographical area within the system map 602 that is represented by the map image 504.

Audio data 506 is processed by voice recognition module 608. The directions extracted from audio data 506 are then utilized by route module 604 to determine a route to be navigated. The audio data 506 may be segmented based on the route, as discussed above with reference to FIG. 3. Mobile GPS device 106(3) then presents the determined route, and the segmented audio data to enable user navigation of the route represented by map annotation message 502.

As illustrated in FIG. 5, the example map image 504 is not based on a pre-generated map foundation. Furthermore, map image 504 may not be drawn to scale. In such an example, the receiving device may process the map image 504 and the audio data 506 in conjunction with one another to facilitate identifying the geographical area represented by the map image 504, and to determine a route represented by the map annotation message 502. For example, the OCR module 606 may extract the road names, “Riverside Ave,” “Division,” “Indiana,”, “Post,” and “Cora” from the map image. The voice recognition module 608 may extract directions and road names, such as, “West on Riverside,” “North on Division,” and “North on Post” from the audio data. Based on the order in which navigational directions and road names are identified in the audio data 506 in combination with the text extracted from the map image 504, the receiving device identifies a geographic region within system map 602. For example, the receiving device locates roads within system map 602 that have the extracted road names and are oriented with relationship to one another in a manner that reflects the directions in the audio data.

### Example Authoring Device

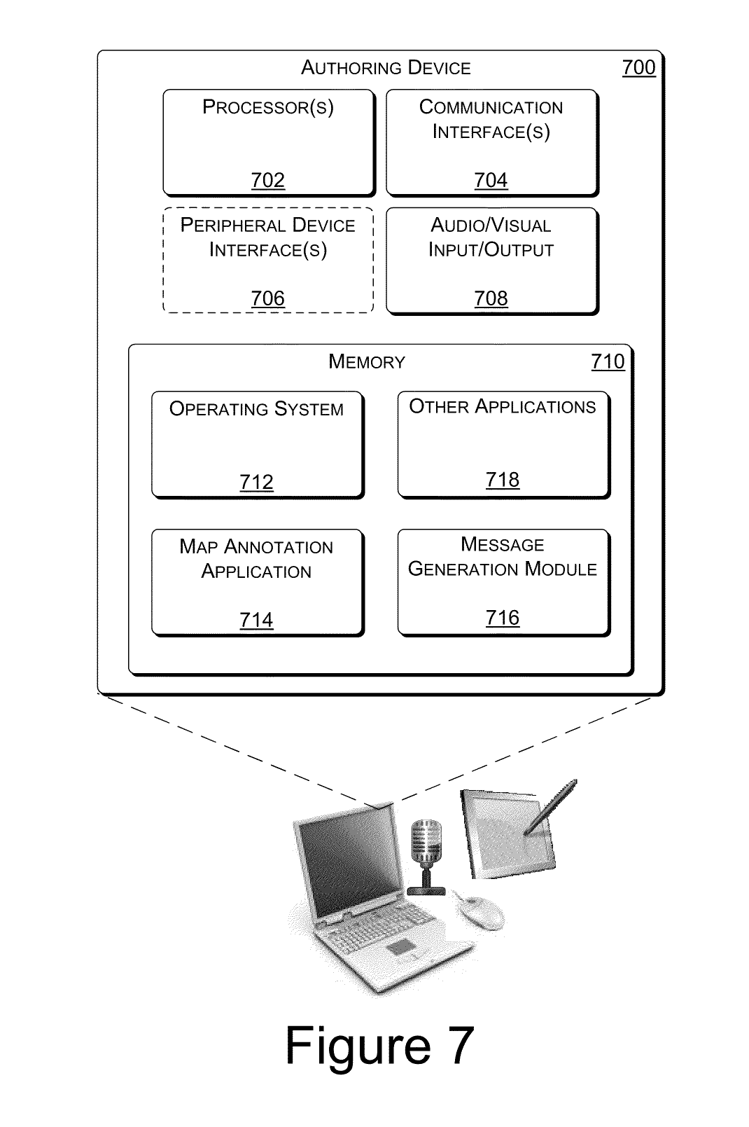

FIG. 7 illustrates select components of an example authoring device 700. As discussed above, computer system 102 is one example of a particular authoring device. Other examples of authoring devices may include, but are not limited to, a personal computer, a mobile phone, a mobile computing device, a portable GPS device, or an in-car navigation system. Example authoring device 700 includes one or more processors 702, one or more communication interfaces 704, optional peripheral device interfaces 706, audio and visual inputs and outputs 708, and memory 710. An operating system 712, a map annotation application 714, a message generation module 716, and any number of other applications 718 are stored in memory 710 and executed on processor 702 to enable authoring of map annotation messages. Although shown as separate components, map annotation application 714 and message generation module 716 may be implemented as one or more applications or modules, or may be integrated as components within a single application.

In the illustrated example, communication interface(s) 704 enable authoring device 700 to transmit a map annotation message, for example, over a network 104. Alternatively, a map annotation message may be transmitted to an intermediary device (e.g., a universal serial bus (USB) storage device), which is then used to transfer the map annotation message to a receiving device. Peripheral device interface(s) 706 enable input of data through peripheral devices, such as, for example, a mouse 110 or other pointer device, a microphone 112, or a pen tablet 114. Authoring device 700 may be implemented to interface with any number of any type of peripheral devices. Furthermore, as indicated in FIG. 7, peripheral device interface(s) 706 are optional. Depending on the authoring device, peripheral device interfaces may or may not exist. For example, a mobile computing device may include a built-in microphone, but not include any additional peripheral device interfaces.

Audio/visual input/output 708 may include a variety of means for inputting or outputting audio or visual data. For example, audio/visual input/output 708 may include, but is not limited to, a display screen, a soundcard and speaker, a microphone, a camera, and a video camera.

Map annotation application 714 represents any application or combination of applications that enables a user to identify or specify a geographic area, and to provide any type of annotation of the geographic area. Examples may include, but are not limited to, any combination of a browser application through which a web-based map service may be accessed, scanning software for receiving a scanned copy of a map, a stand-alone mapping application, or a geographic navigation application.

Message generation module 716 may be implemented as a stand-alone application, or may be a component of a larger application. For example, message generation module 716 may be a component of map annotation application 714. Alternatively, message generation module 716 may be implemented as part of, or used in conjunction with, an email application or a voice over IP (VoIP) telephone application. Message generation module 716 compiles any combination of map annotation data into a single, transmissible message.

Although illustrated in FIG. 7 as being stored in memory 710 of authoring device 700, map annotation application 714 and/or message generation module 716, or portions thereof, may be implemented using any form of computer-readable media that is accessible by authoring device 700. Computer-readable media may include, for example, computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

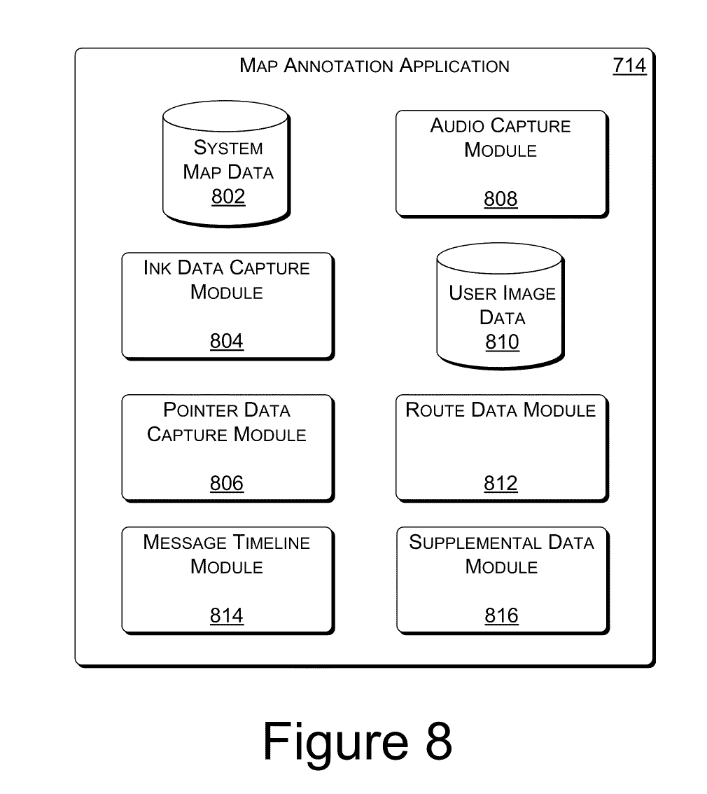

FIG. 8 illustrates select components of an example map annotation application 714. Example map annotation application 714 includes system map data 802, ink data capture module 804, pointer data capture module 806, audio capture module 808, user image data 810, route data module 812, message timeline module 814, and supplemental data module 816.

System map data 802 provides a foundational map on which annotation data may be added. For example, authoring device 700 may include a stand-alone navigation application that includes a pre-generated map of a particular geographic region (e.g., the western United States). As another example, authoring device 700 may be connected to the Internet, and through a browser application, a web-based map service may be accessed (e.g., Microsoft Corporations, Bing™ Maps) to provide a foundational map.

Although the examples given herein illustrate and describe map data that represents large geographic areas, other types of map data are also supported. For example, and not by way of limitation, a map annotation message may be generated to assist a user in navigating an amusement park, a zoo, a museum, a shopping mall, or other similar locations.

Ink data capture module 804 receives and records ink data as input by a user, for example, through a pen tablet or other pointing device configured to record ink data. Similarly, pointer data capture module 806 receives and records pointer data as input by a user, for example, through a mouse or other pointing device configured to control a visual pointer, such as a cursor. In an exemplary implementation, both the ink data and the pointer data is recorded along with a timeline that represents a time at which any particular portion of the ink data or pointer data was input.

Audio capture module 808 receives and records audio input, for example, as input through a microphone. In an exemplary implementation, the audio data is recorded along with a timeline that represents a time at which any particular portion of the audio was input.

User image data 810 stores any type of image data that is input or identified by the user for inclusion with the map annotation message. For example, as described above with reference to FIG. 2, a user may identify a photo of a landmark to be included with a map annotation message. As another example, as described above with reference to FIG. 5, rather than identifying a portion of a pre-defined foundational map, an image of a map may be identified as an image to be included in the map annotation message.

Route data module 812 records data that represents a navigational route to be represented by the map annotation message. For example, a user may generate the map annotation message, at least in part, by accessing a web-based map service and requesting that the service generate driving directions from a start location to a destination. In an alternate implementation, a user may generate a map annotation message, at least in part, by utilizing a personal GPS device, in-car navigation system, or other such device, in a record mode. In this implementation, as the user travels a particular route, data describing the route being traveled is recorded for later inclusion in a map annotation message. The device may also record a user's voice while recording the route, such that the voice data, along with the recorded route data, are then combined to create a map annotation message to be saved and/or transmitted to another device. In an example implementation, recorded route data may be further augmented, for example using a personal computer, with user-submitted ink data, pointer data, supplemental data, etc. to create an enhanced map annotation message. Route data typically includes, for example, segments of a navigational route, and distances associated with each segment.

Message timeline module 814 records a timeline associated with the message. For example, as a user begins creating map annotation data, a message timeline is initiated. One or more of ink data, pointer data, audio data, route data, and image data are recorded in conjunction with the timeline to establish a temporal relationship between each type of data.

Supplemental data module 816 represents any other type of data that may be included in a map annotation message. For example, supplemental data may include, but is not limited to, a universal resource locator (URL) for a web page associated with a particular landmark along a route, a telephone number associated with a start location, a destination, or other location along a route, or an audio or video advertisement for an event that may be occurring along or near the route. In an example implementation, supplemental data may be gathered automatically by map annotation application when a map annotation message is generated, based on route data included in the message. In an alternate implementation, supplemental data may be gathered and added to a previously generated map annotation message in response to a user request to send the map annotation message to a receiving device.

### Example Receiving Device

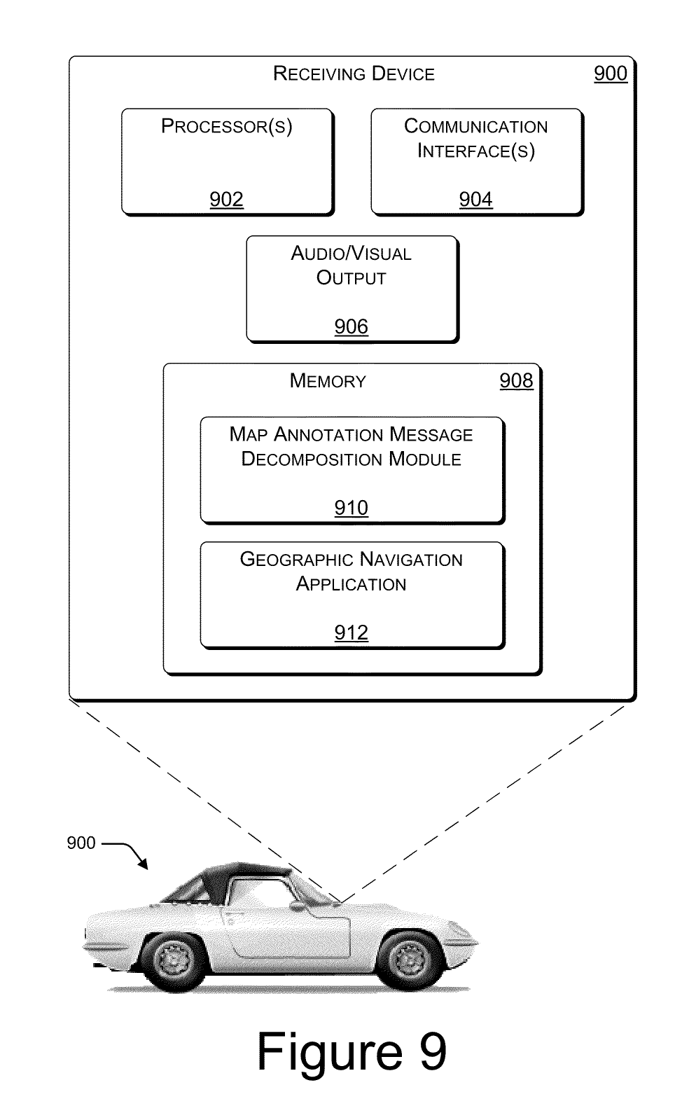

FIG. 9 illustrates select components of an example receiving device 900. As described above, a personal computer, an in-car navigation system, a portable navigation system, a mobile phone, a mobile computing device, and a mobile GPS device are specific examples of a receiving device 900. Example receiving device 900 includes one or more processors 902, one or more communication interfaces 904, audio/visual output 906, and memory 908. A map annotation message decomposition module 910 and a geographic navigation application 912 are stored in memory 908 and executed on processor 902.

Communication interface(s) 904 enable receiving device 900 to receive a map annotation message, for example, over one or more networks, including, but not limited to, the Internet, a wide-area network, a local-area network, a satellite communication network, or a cellular telephone communications network. Depending on the specific implementation, a map annotation message may be sent to a receiving device based on an identifier associated with the receiving device or associated with a user of the receiving device, including for example, an IP address, an email address, a URL, or a telephone number. In an alternate implementation, communication interface 904 may represent a USB port on the receiving device through which a map annotation message may be transmitted from a USB storage device to the receiving device.

Audio/visual output 906 enables receiving device 900 to output audio and/or visual data associated with a map annotation message. For example, receiving device may include a display screen and/or a speaker.

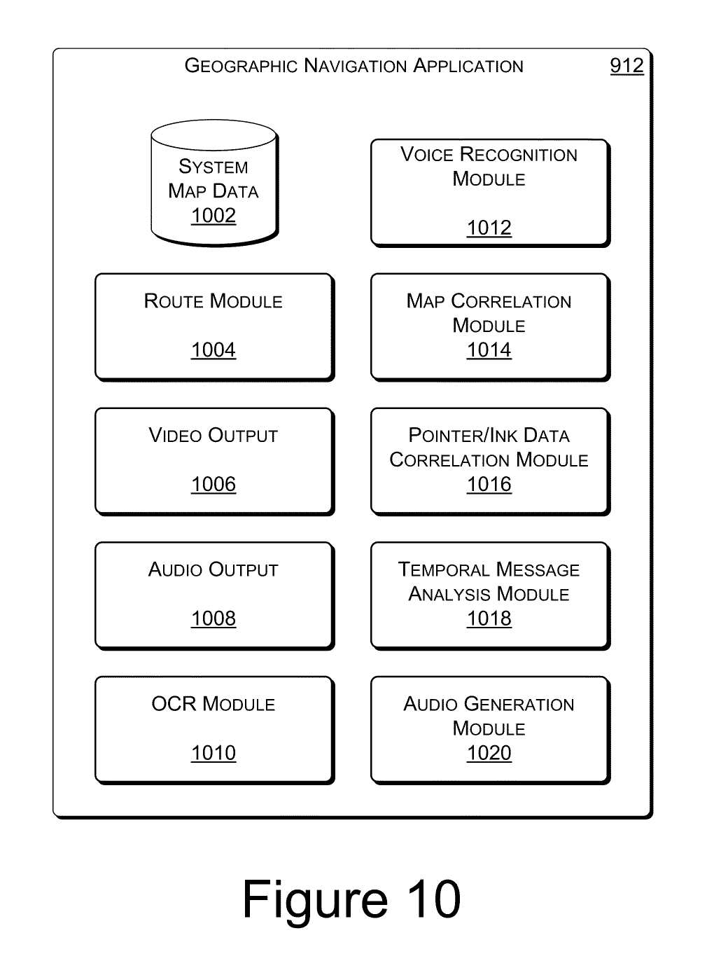

Map annotation message decomposition module 910 is stored in memory 908 and executed on processor 902 to extract components of a received map annotation message. For example, as discussed above with reference to FIGS. 2 and 5, a map annotation message may include a variety of types of data. Map annotation message decomposition module 910 identifies the various types of data included in a particular received map annotation message. In an example implementation, map annotation message decomposition module 910 analyzes one or more components of a received map annotation message. In an alternate implementation, as described below and illustrated in FIG. 10, the received map annotation message may be analyzed by geographic navigation application 912.

Geographic navigation application 912 is stored in memory 908 and executed on processor 902 to provide geographic navigation instructions to a user. For example, an in-car navigation system is configured to receive a destination as an input, and, based on the destination, calculate a route, and present real-time instructions for navigating the route through an audio and/or video output. In an example implementation, when a map annotation message is received, the geographic navigation application 912 presents real-time instructions for navigating a route represented by the map annotation message rather than calculating a route based on a provided destination. The geographic navigation application 912 may generate video output or may present visual data included in the map annotation message. Similarly, the geographic navigation application 912 may generate audio output, or may present audio included as part of the map annotation message.

Although shown as separate components, map annotation message decomposition module 910 and geographic navigation application 912 may be implemented as one or more applications or modules, or may be integrated, in whole or in part, as components within a single application.

Although illustrated in FIG. 9 as being stored in memory 908 of receiving device 900, map annotation message decomposition module 910 and/or geographic navigation application 912, or portions thereof, may be implemented using any form of computer-readable media that is accessible by receiving device 900. Computer-readable media may include, for example, computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism.

FIG. 10 illustrates select components of an example geographic navigation application 912. Example geographic navigation application 912 includes system map data 1002, route module 1004, video output 1006, audio output 1008, OCR module 1010, voice recognition module 1012, map correlation module 1014, pointer/ink data correlation module 1016, temporal message analysis module 1018, and audio generation module 1020. In specific receiving devices, any number of the components shown in FIG. 10 may be optional.

System map data 1002 includes, for example, a pre-defined foundation map that is used to calculate navigation routes. System map data 1002 may include map data stored locally on receiving device 900, or may include a map that is accessible over a network, for example, from a web-based map service.

Route module 1004 includes logic for calculating a route based on a start location, a destination, and the system map data. Route module 1004 is further configured to identify a route represented by data received in a map annotation message. For example, a map annotation message may include well-formatted route data, such as that generated by a web-based map service. Alternatively, route data may be extracted from an audio data component of a map annotation message, and then formatted into route data that is recognized by the geographic navigation application.

Video output 1006 and audio output 1008 enable output of navigation instructions through a video display and/or an audio system.

OCR module 1010 is configured to perform optical character recognition on image data received as part of a map annotation message. For example, as described above with reference to FIG. 5, a map annotation message may include a scanned image of a map sketch. OCR module 1010 is configured to perform optical character recognition on such an image to extract keywords such as road names, landmark names, directions, and so on.

Voice recognition module 1012 is configured to extract words from audio data received as part of a map annotation message. For example, a map annotation message may include spoken directions for navigating a particular route. Voice recognition module 1012 extracts keywords such as road names, landmark names, directions, and so on, from the received audio data.

Map correlation module 1014 is configured to correlate a received map annotation message with system map data 1002. For example, if the map annotation message includes map data that is formatted similarly to system map data 1002, map correlation module 1014 is configured to identify a geographic area represented by the map data in the map annotation message, and identify the same geographic are in the system map data 1002. Alternatively, if the map annotation message does not include well-formatted map data, map correlation module 1014 is configured to analyze other data from the map annotation message to determine a geographic area within system map data 1002 represented by the map annotation message. For example, based on street names and landmarks mentioned in an audio data component of the map annotation message, the map correlation module 1014 is configured to locate a geographic area that includes streets having those same names.

Pointer/ink data correlation module 1016 is configured to correlate pointer data and/or ink data from a received map annotation message with system map data 1002. For example, a route traced by a user with digital ink when then map annotation message was created is matched up with specific locations in system map data 1002. Similarly, landmarks or other points of interest that may be indicated by pointer data within the map annotation message are identified in system map data 1002.

Temporal message analysis module 1018 is configured to analyze multiple components of a map annotation message in temporal relation to one another. For example, a map annotation message may include ink data, pointer data, and/or audio data, each of which may have an associated timeline that represents a time span over which the data was input by a user. If the timelines overlap (e.g., the user was recording themselves speaking directions while moving a cursor along a route on a map, recording the pointer data), then temporal message analysis module is configured to correlate portions of the audio data with portions of the pointer data that correspond to distinct segments of a navigation route. Temporal message analysis module 1018 may also be configured to identify route segments to which image data in the map annotation message corresponds. For example, an image of a landmark may be correlated with a segment of a route that is closest to the landmark shown in the image, based on keywords and timeline information extracted from audio data in the map annotation message.

Audio generation module 1020 is configured to generate spoken audio cues to direct a user to navigate a particular route. For example, when a user enters a destination into an in-car navigation system, the system provides spoken directions to the user as the user navigates a calculated route to the destination. Similarly, audio generation module 1020 may generate audio to be presented along with a route represented by a map annotation message. In an example implementation, if a received map annotation message does not include audio data, audio generation module 1020 generates spoken navigation instructions that correspond with the route represented by the map annotation message. In an alternate implementation, if the map annotation message includes audio data, the audio generation module 1020 generates spoken navigation instructions for presentation along with the audio data from the map annotation message. For example, the audio data from the map annotation message may include directions, but may be lacking any information regarding distance. Based on the determined route, audio generation module 1020 may generate additional audio that provides distances for each route segment, and receiving device 900 may present the generated audio in conjunction with the audio data included in the map annotation message.

### Example Operation

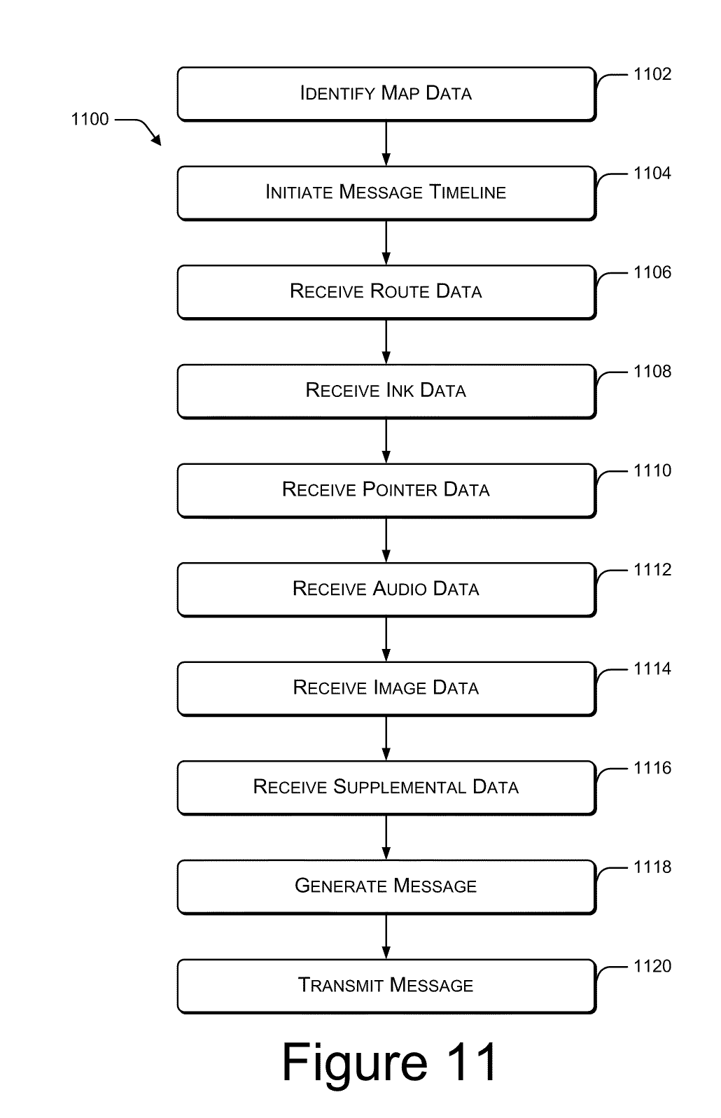

FIGS. 11-14 are flow diagrams of example processes for generating, receiving, and presenting a map annotation message. These processes are illustrated as collections of blocks in logical flow graphs, which represent sequences of operations that can be implemented in hardware, software, or a combination thereof. In the context of software, the blocks represent computer-executable instructions stored on one or more computer-readable media that, when executed by one or more processors, cause the processors to perform the recited operations. Note that the order in which the processes are described is not intended to be construed as a limitation, and any number of the described process blocks can be combined in any order to implement any of the processes, or alternate processes. Additionally, individual blocks may be deleted from any of the processes without departing from the spirit and scope of the subject matter described herein. Furthermore, while these processes are described with reference to the authoring device 700 and receiving device 900 described above with reference to FIGS. 7-10, other computer architectures may implement one or more of these processes in whole or in part.

FIG. 11 illustrates an example process 1100 for generating a map annotation message. As discussed above with reference to FIGS. 2 and 5, map annotation messages may include any combination of data types. For example, a map annotation message may include a single data type (e.g., a scanned in image of a map, route data, or audio data in the form of spoken navigation directions), or a map annotation message may include multiple data types (e.g., map data, ink data, and audio data). FIG. 11 illustrates a process for generating a map annotation message with multiple data types, however, any one or more of the blocks shown in FIG. 11 may be optional for a particular map annotation message.

At block 1102, map data is identified. For example, a geographic area may be selected from a web-based map service or a map annotation application 714 stored locally on an authoring device 700. Alternatively, a map may be scanned into the system in electronic form based on a hard copy. A map that is scanned in may be based on an accurate, professionally crafted map, or it may be based, for example, on a sketch, which may or may not be to scale.

At block 1104, a message timeline is initiated. For example, message timeline module 814 notes a start time of the message annotation. The timeline is generated to provide temporal context for data in the map annotation message.

At block 1106, route data is received. For example, using a web-based map service or local geographic application, a user may enter a starting location and a destination. Based on the staring location and the destination, the web-based map service or local geographic application may calculate a route. Alternatively, a user may use a geographic application to specify a route between the starting location and the destination. In another alternate implementation, a route may be recorded as it is traveled using, for example a record mode of a personal GPS device or in-car navigation system. In an example implementation, route data includes route segments (e.g., defined by changes in location, changes in road names, or turns), directions (e.g., north, south, east, west, left, right, etc.), and segment lengths.

At blocks 1108 and 1110, ink data and pointer data is received. For example, using a designated pointer device (e.g., a pen tablet 114, mouse 110, or finger on a touch screen), a user digitally annotates the map with freeform lines or other markings that are recorded as ink data. Similarly, a user may use such a designated pointer device to point to locations on the map or trace a route on the map. Such pointing is recorded as non-marking pointer data. In an example implementation, ink data capture module 804 captures ink data, while pointer data capture module 806 captures pointer data.

At block 1112, audio data is received. For example, using a microphone 112, a user records spoken directions for navigating from a starting location to a destination location. The audio may also include, for example, commentary regarding landmarks along the route.

At block 1114, image data is received. For example, a user identifies an image of a landmark that is located along, or visible from, the described route. In an example implementation, an image may be uploaded from a camera, downloaded from the Internet, or identified on a local storage device.

At block 1116, supplemental data is received. For example, a website associated with a landmark along the route may be determined. In an example implementation, a user may enter supplemental data. In an alternate implementation, message generation module 716 identifies points of interest along a route represented by the map annotation data, and automatically searches for related supplemental data.

At block 1118, a map annotation message is generated. For example, message generation module 716 formats data received through map annotation application 714, and packages the data as a map annotation message. Any number of formats may be used to package a map annotation message, including, but not limited to, a configuration file (e.g., a .ini file), a text file, or a markup language document (e.g., an XML file).

At block 1120, the map annotation message is transmitted to a receiving device. For example, the map annotation message may be sent over a network to a receiving device. The network may be any type of network, including but not limited to, the Internet, a wide-area network, a local-area network, a satellite network, a cable network, or a cellular telephone network. In an example implementation, when transmitted over a network, the map annotation message may be addressed to the receiving device using an email address, an IP address, a phone number, any other type of user or device identifier. Alternatively, the map annotation message may be saved to a portable storage device, which is then transferred from the authoring device 700 to a receiving device 900.

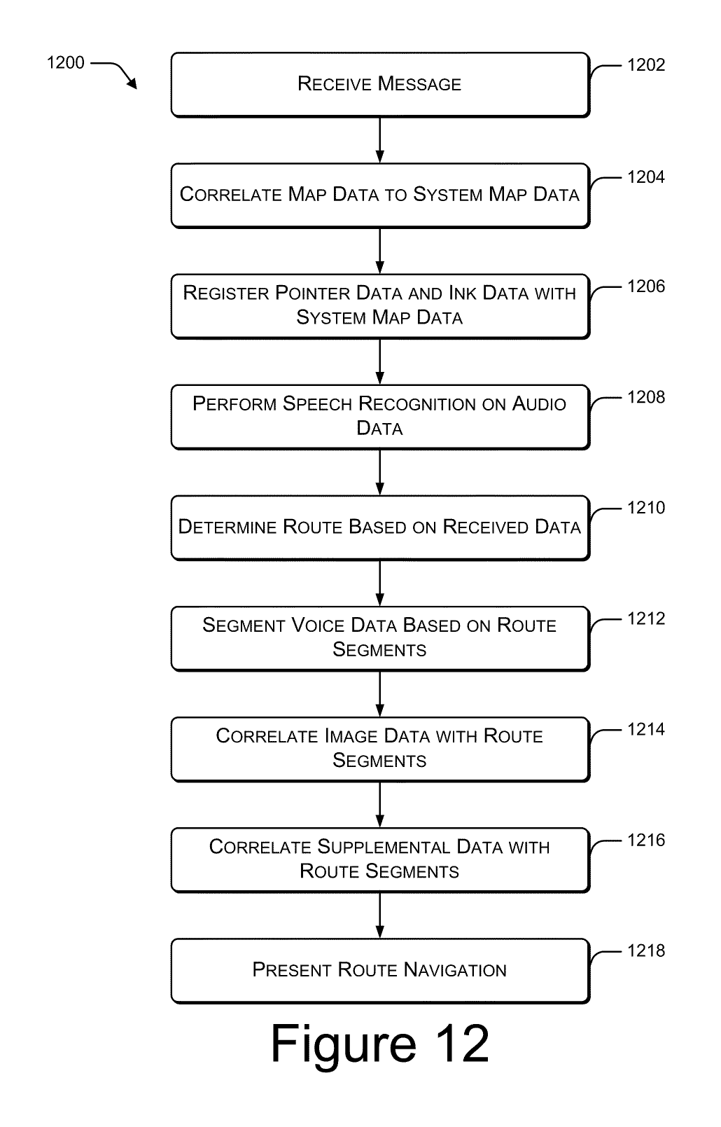

FIG. 12 illustrates an example process for receiving and processing a map annotation message. As discussed above with reference to FIGS. 2 and 5, map annotation messages may include any combination of data types. For example, a map annotation message may include a single data type (e.g., a scanned in image of a map, route data, or audio data in the form of spoken navigation directions), or a map annotation message may include multiple data types (e.g., map data, ink data, and audio data). FIG. 12 illustrates a process for receiving and presenting a map annotation message with multiple data types, however, any one or more of the blocks shown in FIG. 12 may be optional for a particular map annotation message

At block 1202, the message is received. For example, receiving device 900 receives a map annotation message through communication interface 904.

At block 1204, map data included in the map annotation message is correlated to system map data associated with the receiving device. For example, if the map annotation message includes well-formatted map data, map correlation module 1014 extracts boundaries of the received map data and correlates those boundaries to system map data 1002. In an alternate example, as illustrated in FIG. 5, the map annotation message may include a scanned image of a map, which may or may not be to scale. In such an example, OCR module 1010 performs optical character recognition against the map data to identify locations, such as street names, which are then used by map correlation module 1014 to correlate the received map data with the system map data 1002.

At block 1206, pointer data and/or ink data included in the map annotation message is registered with the system map data. For example, pointer/ink data correlation module 1018 identifies locations associated with pointer data and/or ink data in the map annotation message. These locations are identified in relation to system map data 1002.

At block 1208, voice recognition is performed on audio data included in the map annotation message. For example, voice recognition module 1012 performs voice recognition on any received audio data.

At block 1210, a navigation route is determined based on the data in the received message. If the map annotation message includes route data, then route module 1004 correlates the received route data with the system map data to create route data that is formatted for the receiving device. Alternatively, a combination of pointer data, ink data, audio data, and/or map data is analyzed to determine a route represented by the map annotation message. For example, temporal message analysis module 1016 analyzes temporal relationships between keywords extracted from the audio data and locations represented by the pointer data and ink data to identify a series of locations. Route module 1004 uses geographic relationships within the series of locations, along with direction words extracted from the audio data to construct a route consistent with the data received in the map annotation message.

As described above, route data, whether received in the map annotation message or generated by route module 1004, is made up of route segments. At block 1212, the audio data is segmented based on segments of the determined route. For example, geographic navigation application 912 uses data extracted using voice recognition module 1012 and the determined route to segment the audio data such that each audio segment corresponds with a particular segment of the route. Temporal message analysis module 1018 may also be utilized to segment the received audio data.

At block 1214, image data included in the map annotation message is correlated with segments of the determined route. For example, temporal message analysis module 1016 identifies temporal relationships between an image included in the map annotation message and the pointer/ink data and/or the audio data to determine a route segment with which the image is related. For example, when the map annotation message was created, the image file may have been referenced when the message author was describing a particular landmark along a particular roadway. Accordingly, a temporal relationship exists between the audio data describing the landmark, ink or pointer data along the particular roadway, and the image data. Based on this relationship, the image data is associated with the route segment that includes the particular roadway.

At block 1216, supplemental data included in the map annotation message is correlated with segments of the determined route. For example, temporal message analysis module 1016 identifies temporal relationships between supplemental data included in the map annotation message and the image data, the pointer/ink data, and/or the audio data to determine a route segment with which the supplemental data is related.

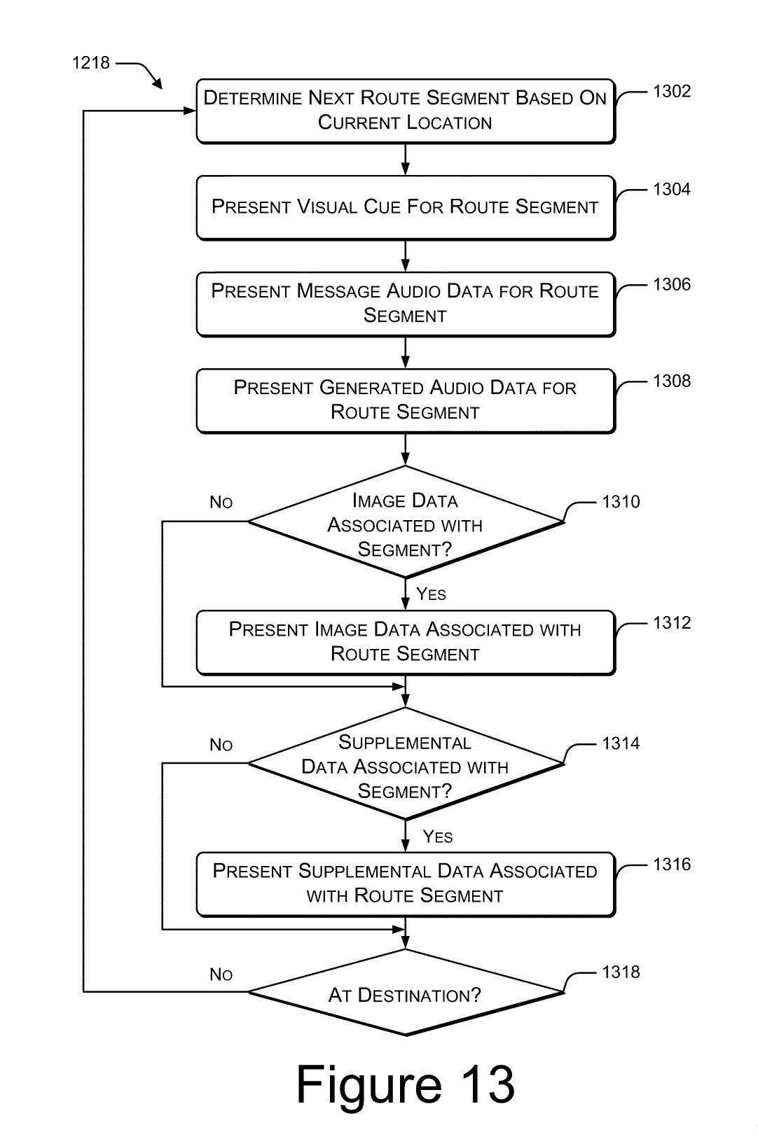

At block 1218, the message is presented as a navigation route. Presentation of the map annotation message is described in further detail below, with reference to FIG. 13.

FIG. 13 illustrates an example process 1218 for presenting a map annotation message.

At block 1302, a next route segment is determined based on a current location. For example, geographic navigation application 912 uses GPS technology to identify a current location, and based on the current location, determines a next segment of a route being navigated.

At block 1304, a visual cue for the route segment is presented. For example, geographic navigation application may present an arrow to the right on a display screen, visually indicating an upcoming right hand turn.

At block 1306, audio data from the map annotation message is presented for the route segment. For example, geographic navigation application 912 presents a portion of the audio data from the map annotation message that was recorded while pointer data was entered along a portion of the map corresponding to the route segment.

At block 1308, generated audio data is presented for the route segment. For example, geographic navigation application 912 presents audio generated by the geographic navigation application 912 that corresponds to the route segment. For example, if the map annotation message does not include audio that corresponds to the segment, generated audio is presented. As another example, the audio data in the map annotation message may provide directions, but no distance, so the generated audio may provide the distance information. As a third example, audio that would normally be generated by the geographic navigation application 912 to assist in route navigation may be presented subsequent to, or instead of, any map annotation message audio data that may exist.

At block 1310, geographic navigation application 912 determines whether or not the map annotation message includes image data that corresponds with the route segment. If the message includes image data that corresponds with the route segment (the “Yes” branch from block 1310), then at block 1312, the image data is presented. For example, an image of a landmark may be displayed on a display screen associated with receiving device 900.

At block 1314, geographic navigation application 912 determines whether or not the map annotation message includes supplemental data that corresponds with the route segment. If the message does include supplemental data that corresponds with the route segment (the “Yes” branch from block 1314), then at block 1316, the supplemental data is presented. For example, a URL for a web page associated with a nearby landmark, or the actual web page, may be presented on a display screen associated with receiving device 900.

At block 1318, geographic navigation application 912 determines whether or not a current location is sufficiently near the destination associated with the route being navigated. If the destination has not yet been reached (the “No” branch from block 1318), then presentation continues as described above with reference to block 1302.

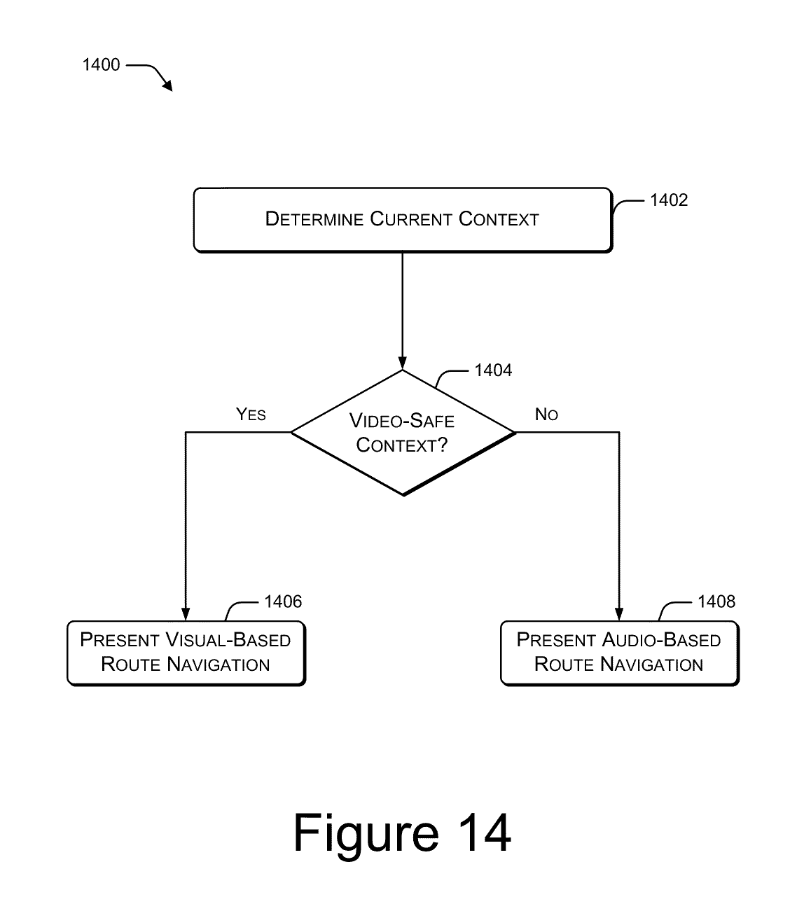

FIG. 14 illustrates an example process 1400 for presenting a map annotation message based on a current context. Context may be determined based on any number of factors, including, but not limited to, a user-defined setting on the receiving device, a user activity level, a current speed, and so on.

At block 1402, a current context is determined. For example, if the receiving device is capable of functioning in multiple modes, the current context may be based on a current mode of the device. For example, a mobile phone may be in a first mode (associated with a first context) while a user is making a call, and may be in a second mode (associated with a second context) while executing a geographical navigation application. As another example, a portable GPS device may determine a context based on a calculated speed at which the device is moving, indicating that a user of the GPS device may be walking, riding a bicycle, or traveling in a vehicle.

At block 1404, a determination is made as to whether or not the determined context is a video-safe context. For example, if the context is determined based on a calculated speed, if the speed is slower than a pre-defined threshold speed, it may be determined that a visual-based presentation of route navigation cues is safe. Alternatively, if a calculated speed is faster than a pre-defined threshold speed (e.g., indicating that the user of the device may be driving a vehicle), then it is determined that a visual-based presentation of route navigation cues is not safe.

If it is determined that the current context is a video-safe context (the “Yes” branch from block 1404), then at block 1406, visual-based route navigation cues are presented.

On the other hand, if it is determined that the current context is not a video-safe context (the “No” branch from block 1404), then at block 1408, audio-based route navigation cues are presented. For example, receiving device 900 may prevent presentation of data representing ink or pointer data, image data, or supplemental data, and instead, present only audio data corresponding to a route represented by the map annotation message.

FIG. 14 provides one example of context-based map annotation message presentation. In other example implementations, other factors may be used to determine a current context, and other combinations of data from a map annotation message may be presented depending on a current context.

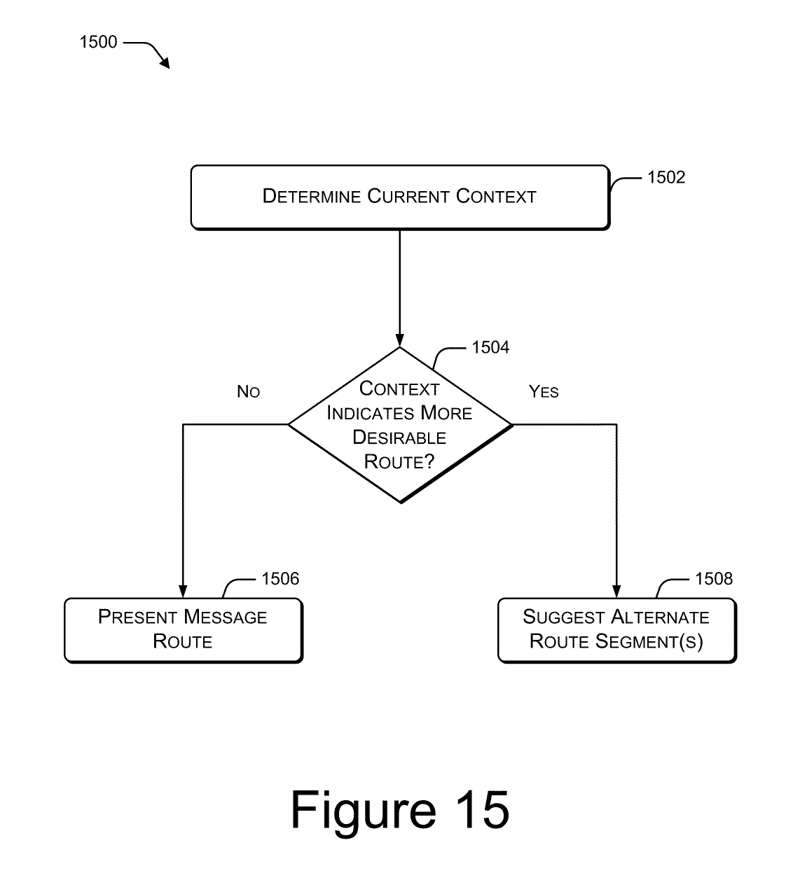

For example, FIG. 15 illustrates another example process 1500 for presenting a map annotation message based on a current context. In this example implementation, context may be determined based on any number of factors, including, but not limited to, current weather conditions, traffic density, time of day, and so on.

At block 1502, a current context is determined. For example, the receiving device may access current weather or traffic conditions over the Internet, or may determine a current time.

At block 1504, a determination is made as to whether or not the determined context indicates a more desirable route. For example, if the current traffic conditions or time of day suggest that traffic is dense along the route indicated by the received message (e.g., rush-hour city traffic), then the receiving device determines that an alternate route may be desired. As another example, if the received map annotation message indicates that the route represented by the map annotation message is a scenic route, but the current time is after dark, then the receiving device may determine that a shorter, more direct route may be more desirable.

If it is determined that the current context does not indicate a more desirable route (the “No” branch from block 1504), then at block 1506, the route represented by the received map annotation message is presented.

On the other hand, if it is determined that the current context does indicate a more desirable route (the “Yes” branch from block 1504), then at block 1508, one or more alternate route segments are suggested. For example, receiving device 900 may determine one or more alternate routes based on a current location and a destination represented by the map annotation message. The alternate route may be determined, for example, according to algorithms implemented on the receiving device.

### Conclusion

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims.

What is claimed is:

1. A method implemented on a receiving device, the method comprising:
receiving a message that includes map annotation data, the message being received from a source external to the receiving device;
determining a route indicated by the map annotation data; and
presenting the route through an output associated with the receiving device.

2. A method as recited in claim 1, wherein the map annotation data includes map data, the method further comprising correlating the map data with a system map associated with the receiving device.

3. A method as recited in claim 2, wherein the map data comprises a scanned image of a map.

4. A method as recited in claim 2, wherein the map data comprises a representation of a building floor plan.

5. A method as recited in claim 1, wherein the map annotation data comprises one or more of:
map data;
pointer data;
ink data;
route data;
audio data; or
image data.

6. A method as recited in claim 1, wherein the map annotation data comprises audio data, the method further comprising:
performing speech recognition on the audio data;
segmenting the audio data based on segments of the route;
playing segments of the audio data while presenting the route, such that at any given time, a segment of the audio data that is being played corresponds with a segment of the route that is currently being presented.

7. A method as recited in claim 1, wherein the map annotation data includes pointer data or ink data, the method further comprising:
registering the pointer data or ink data with a system map associated with the receiving device; and
determining the route based on the pointer data or ink data.

8. A method as recited in claim 7, wherein:
the map annotation data further includes audio data; and
the pointer data or the ink data is registered relative to the system map based, at least in part, on location data extracted from the audio data.

9. A system for receiving and presenting map annotation messages, the system comprising:
a communication interface for receiving a map annotation message;
a processor;
a memory;
map annotation message decomposition instructions stored in the memory and executed on the processor to extract data from the map annotation message;
geographic navigation instructions stored in the memory and executed on the processor to present instructions for navigating a route represented by the map annotation message.

10. A system as recited in claim 9, wherein the map annotation message decomposition instructions comprise voice recognition instructions for extracting words from audio data associated with the map annotation message.

11. A system as recited in claim 9, wherein the map annotation message decomposition instructions comprise temporal message analysis instructions for analyzing temporal relationships between each of a plurality of data types in the map annotation message.

12. A system as recited in claim 9, wherein the map annotation message decomposition instructions comprise optical character recognition instructions for extracting text from a map image.

13. A system as recited in claim 9, wherein the geographic navigation instructions comprise audio generation instructions for generating audio that is associated with the route represented by the map annotation message.

14. A system as recited in claim 9, wherein the map annotation message decomposition instructions comprise:
data correlation instructions for correlating pointer data or ink data from the map annotation message with map data;
voice recognition instructions for extracting words from audio data associated with the map annotation message.

15. One or more computer readable media encoded with instructions that, when executed on a processor, direct the processor to perform operations comprising:
receiving a map annotation message, the map annotation message including any combination of:
map data;
route data;
audio data;
pointer data;
ink data;
image data; or
supplemental data;
determining a route represented by the map annotation message; and
presenting the route represented by the map annotation message.

16. One or more computer readable media as recited in claim 15, wherein:
determining the route represented by the map annotation message includes:
performing voice recognition on the audio data to extract navigation keywords;
determining temporal relationships between the audio data, the pointer data, and the ink data;
correlating the map data, the route data, the pointer data, the ink data, and the navigation keywords extracted from the audio data with a system map;
segmenting the audio data based on segments of the route represented by the map annotation message; and
associating the image data with one or more segments of the route represented by the map annotation message; and
presenting the route represented by the map annotation message includes:
presenting a visual representation of navigation directions for a particular segment of the route represented by the map annotation message;
presenting a portion of the audio data of the map annotation message that corresponds with the particular segment of the route represented by the map annotation message; and
presenting image data of the map annotation message that corresponds with the particular segment of the route represented by the map annotation message.

17. One or more computer readable media as recited in claim 15, wherein presenting the route represented by the map annotation message comprises:
determining a context within which a navigation device is being used;
based on the context, presenting a portion of data included in the map annotation message and not presenting another portion of the data included in the map annotation message.

18. One or more computer readable media as recited in claim 15, wherein the map annotation message includes route data that was recorded in real-time as an author of the map annotation message navigated the route.

19. One or more computer readable media as recited in claim 15, wherein presenting the route represented by the map annotation message comprises:
generating additional audio data separate from the map annotation message; and
presenting the additional audio data in addition to presenting the audio data included in the map annotation message.

20. One or more computer readable media as recited in claim 15, wherein presenting the route represented by the map annotation message comprises:
generating additional audio data separate from the map annotation message; and
presenting the additional audio data instead of presenting the audio data included in the map annotation message.
